(19) United States
(12) Patent Application Publication
(10) Pub. No.: US 2015/0307647 A1
(43) Pub. Date: Oct. 29, 2015

(54) PROCESS FOR PRODUCING FLEXIBLE POLYURETHANE FOAMS WITH HIGH COMFORT VALUE AND LOW HYSTERESIS LOSSES

(71) Applicant: BAYER MATERIALSCIENCE AG, Leverkusen (DE)

(72) Inventors: Gundolf JACOBS, Rösrath (DE); Hans-Detlef ARNTZ, Lohmar (DE); Hans-Georg PIRKL, Leverkusen (DE); Angelika SCHULZ, Leverkusen (DE)

(21) Appl. No.: 14/646,411

(22) PCT Filed: Nov. 18, 2013
(86) PCT No.: PCT/EP2013/074021

§ 371 Date: May 21, 2015

(30) Foreign Application Priority Data
Nov. 23, 2012 (EP) 12193979.7

(51) Int. Cl. C08G 18/76; C08G 18/18; C08G 18/08; C08G 18/48

(52) U.S. Cl. CPC C08G 18/7664; C08G 18/485; C08G 18/1825; C08G 18/0838; C08G 2101/0008

(57) ABSTRACT

The present invention relates to a process for producing flexible polyurethane (PUR) foams with high comfort value and low hysteresis losses produced by reacting organic polyisocyanates containing di- and polyisocyanates of the diphenylmethane (MDI) group with polyoxyalkylene polyethers.

The present invention relates to a process for producing flexible polyurethane (PUR) foams with high comfort value and low hysteresis losses obtained by reacting organic polyisocyanates containing di- and polyisocyanates of the diphenylmethane (MDI) series with polyoxyalkylene polyethers.

Flexible PUR foams are obtained by reacting organic polyisocyanates such as, for example, tolylene diisocyanate (TDI) and/or diphenylmethane diisocyanates (MDI) with polyoxyalkylene polyethers. The latter have been extensively described because their construction has an effect on the physical properties of flexible PUR foams such as, for example, open-cell character and elasticity for the resulting foams.

EP-A 0 547 765 discloses flexible PUR foams obtained by reacting isocyanate blends with polyoxypropylene-polyoxyethylene polyethers wherein the isocyanate mixture contains at least 85 wt % of the 4,4′-MDI isomer and the polyether polyols have an ethylene oxide content of 60-85 wt %. These foams are highly open-cell in character and tend to collapse in the course of processing.

WO-A 01/032735 discloses a high-resilience PUR foam being obtained as a product of reacting an isocyanate prepolymer having a 4,4′-MDI content of at least 80 wt % and a free NCO value of below 20 wt % with a polyether mixture containing at least two polyether polyols whereof one has an ethylene oxide content of more than 50 wt % and a further polyether polyol has an ethylene oxide content between 20 and 50 wt %, and this in the form of a mixed block and/or as an EO end-block. The disadvantage of foams thus obtained is their low load-bearing capacity specifically under moist conditions.

WO-A 2004/014976 discloses an isocyanate prepolymer, a polyol composition and a process for producing a flexible PUR foam wherein the prepolymer is formed from a specific EO-rich (21-45 wt % of ethylene oxide, based on the sum total of alkylene oxides) polyoxyethylene-polyoxypropylene polyether and a 4,4′-MDI-rich (≧80 wt % of 4,4′-MDI) isocyanate mixture reacted with 30-100 parts of a further EO-rich (≧50 wt % of ethylene oxide based on the sum total of alkylene oxides) polyether polyol. An overpack of below 30% or excessive venting of the mold will cause reaction mixtures of this type to collapse, making consistent process control difficult. Overpack is the proportion of reaction mixture injected into a mold in excess of what is needed to fill the in-mold cavity with a free-rise foam.

US-A 2003/0158280 describes a process for producing a flexible FUR foam wherein an MDI mixture consisting of 11 to 75 wt % 4,4′-MDI and 18 to 85 wt % of the 2,4′ and 2,2′MDI isomers and up to 25 wt % of higher MDI homologs and also optionally up to 20 wt % of TDI is reacted in the presence of water with a mixture of an EO-rich and an EO-lean polyether polyol.

WO-A 02/068493 discloses a process for producing flexible polyurethane foams by reacting prepolymers having NCO values of between 5 and 30 wt %, which are derived from the reaction product of 80 to 100 wt % MDI having an at least 40 wt % proportion of the 4,4′-isomer and 20 to 0 wt % of some other polyisocyanate and a polyether polyol having a functionality of 2 to 8, an OH number of 9 to 225 mg KOH/g and an ethylene oxide content of 50 to 100 wt % and also a further polyether polyol having but for the ethylene oxide content of 0 to 25 wt % the same characterization and an isocyanate-reactive component consisting predominantly of an EO-rich polyether polyol. In addition to the processing disadvantage that such EO-rich foams are very open-cell in character and tend to collapse, their water imbibition is very high and their aging resistance consequently tends to be insufficient. An interrelationship between foam quality and a certain isomeric ratio in the isocyanate component is not disclosed.

EP-A 1 213 310 discloses polyisocyanate compositions and processes for producing flexible FUR foams. The polyisocyanate compositions described therein contain EO-rich polyether polyols having an ethylene oxide fraction of more than 50 wt %. A preferred ratio to be used between the 4,4′ and 2,4′ MDI isomers is not disclosed. Isocyanate compositions are exemplified where the 4,4′ and 2,4′ MDI isomer ratio is equal to 1.55 (inventive example as per EP-A 1 213 310) and equal to 3.2 (comparative example as per EP-A 1 213 310).

EP-A 0 555 721 discloses the production of molded high-resilience foams on the basis of MDI, which are obtainable by using highly EO-containing polyethers with certain isocyanate mixtures. The interrelationship between foam quality and the ratio of 4,4′ and 2,4′ MDI isomers is not disclosed.

WO-A 2012/069384 discloses flexible PUR foams based on renewable raw materials comprising 5-50 wt % polyricinoleic esters in admixture with conventional polyethers. Interrelationship between foam quality and the ratio of the 4,4′ and 2,4′ MDI isomers is not disclosed.

DE-A 102 11 975 discloses flexible PUR foams having an apparent density up to 60 kg/m³, the polyol mixture of which is composed of EO-rich and EO-lean polyether polyols and which have a hysteresis of less than 20%. The ratio disclosed therein for the 4,4′ and 2,4′ MDI isomers of the polyisocyanate component is in the range of 0.5-3. The influence of isomer ratio on foam quality is not disclosed.

US-A 2011/0269863 discloses flexible PUR foams that are based on fatty acid esters and have an apparent density of up to 50 kg/m³ and a hysteresis in the range of 15-17%. An interrelationship between foam quality and the ratio of 4,4′ and 2,4′ MDI isomers is not disclosed.

Seating applications in the automotive sector utilize flexible PUR foams based on diphenylmethane diisocyanates and having apparent densities of above 50 kg/m′ preferably above 63 kg/m³. The upper limit to the apparent density, unlike the lower limit, is not specified in the literature. Apparent densities of above 85 kg/m³ are uncommon, since comparatively high apparent densities are economically disadvantageous and entail a higher level of hardness for a given formulation, since the hardness of the foams correlates directly with the apparent density. The outermost layer of a seat is the foam part which has to meet the highest comfort requirements with a target hardness of 5.0 to 9.0 kPa.

For a given formulation water content, hardness is fine-tuned via adjustment of part density and/or the isocyanate index, which is typically varied in the range from 75 to 110, preferably in the range from 80 to 105.

The isocyanate index indicates the ratio of the isocyanate quantity actually used to the stoichiometric, i.e., computed, quantity of isocyanate (NCO):

isocyanate index=[(isocyanate quantity used):(isocyanate quantity computed)]*100 (1)

None of the documents cited discloses the ratio of 4,4′-MDI to 2,4′-MDI isomers interrelating to the properties of flexible PUR foams, specifically not to a reduction in hysteresis loss.

The problem addressed by the present invention was that of providing a process for producing high-resilience flexible PUR foams having good moisture resistance as well as particularly low hysteresis losses (≦16% at a minimum apparent density of 50 kg/m³), since low hysteresis values, being a measure of good elastic properties on the part of a foam, are important for sitting comfort. Hysteresis (CLD) is determined in accordance with DIN EN ISO 2439-1-2009.

It was found that, surprisingly, high-resilience flexible PUR foams having good mechanical properties and hysteresis losses ≦16% are obtainable with an ethylene oxide (EO) fraction of ≦30 wt % preferably ≦20 wt %, based on the sum total of all alkylene oxide fractions in the polyether polyols used for producing the flexible PUR foam, when the ratio of 4,4′-MDI to 2,4′-MDI in the polyisocyanate mixture used is between 1.6 and 2.7.

The invention accordingly provides a process for producing flexible PUR foams having a DIN EN ISO 3386-1-98 apparent density in the range of ≧63 kg/m³ to ≦83 kg/m³ and a DIN EN ISO 2439-1-2009 hysteresis loss of ≦16 by reaction of component A containing
A1 at least one polyether polyol having a functionality of 2 to 6, preferably 2 to 4, a DIN 53240 hydroxyl number (OH number) of 9 to 112 mg KOH/g, an ethylene oxide fraction of 5 to 40 wt %, preferably of 5 to 30 wt % and more preferably of 10 to 20 wt % (based on the sum total of alkylene oxides used),
A2 water and/or physical blowing agents,
A3 optionally isocyanate-reactive hydrogen compounds having an OH number of 140 tug KOH/g, to 1800 mg KOH/g,
A4 auxiliary and added-substance materials such as
   a) catalysts,
   b) surface-active added-substance materials, and
   c) pigments or flame retardants,
wherein component A is free of polyricinoleic ester, and
with
component B containing
   a mixture of di- and polyisocyanates of the diphenylmethane (MDI) series (B1)
   and optionally one or more polyether polyols (B2) having a functionality of 2 to 8, preferably of 2 to 6, a DIN 53240 OH number of ≧9 mg KOH/g to ≦56 mg KOH/g, preferably of ≧25 mg KOH/g to ≦45 mg KOH/g,
   wherein the ratio of 4,4′-MDI to 2,4′-MDI is between 1.6 and 2.7
   and total monomer content is 75 to 85 wt %, based on the sum total of isocyanates used, wherein the flexible PUR foam, preferably the molded flexible PUR foam, is produced at an isocyanate index of 75 to 110, preferably 80 to 105.

The invention further provides the flexible PUR foams obtained by the process according to the invention, preferably molded flexible PUR foams obtained by the process according to the invention, and also for their use in the manufacture of moldings and the moldings themselves,

In one embodiment of the invention, the flexible PUR foam, preferably the molded flexible PUR foam, is obtainable by reacting 100 parts by weight of A1, 0.5 to 5 parts by weight, preferably 1.0 to 4.0 parts by weight, more preferably 2.0 to 3.2 parts by weight (based on 100 parts by weight of component A1) of A2, 0 to 10 parts by weight, preferably 0.05 to 5 parts by weight (based on 100 parts by weight of component A1) of A3 and 0.05 to 10 parts by weight, preferably 0.2 to 4 parts by weight (based on 100 parts by weight of component A1) of A4 with component B.

Component A

Component A is free of polyricinoleic esters.

Component A1

Starting components as per component A1 are polyether polyols. The appellation of polyether polyols useful for the purposes of the invention is applied to compounds that are alkylene oxide addition products of starter compounds having Zerewitinoff-active hydrogen atoms, i.e., polyether polyols having a DIN 53240 hydroxyl number of ≧9 mg KOH/g to ≦112 mg KOH/g, preferably of ≧15 mg KOH/g to ≦80 mg KOH/g and more preferably of ≧20 mg KOH/g to ≦60 mg KOH/g. Polyether polyols Al according to the invention have an ethylene oxide fraction of 5 to 40 wt %, preferably of 5 to 30 wt % and more preferably of 10 to 20 wt % based on the sum total of alkylene oxides used.

The functionality of polyether polyols is determined by the functionality of starter compounds used for producing the polyether polyols.

The starter compounds used for producing the polyether polyols have Zerewitinoff-active hydrogen atoms and usually functionalities of 2 to 6, preferably of 2 to 4, and are preferably hydroxyl functional. Examples of hydroxyl-functional starter compounds are propylene glycol, ethylene glycol, diethylene glycol, dipropylene glycol, 1,2-butanediol, 1,3-butanediol, 1,4-butanediol, hexanediol, petitanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene, methylolyl-containing condensates of formaldehyde and phenol or melamine or urea. The starter compound used is preferably glycerol and/or trimethylolpropane.

Suitable alkylene oxides include, for example, ethylene oxide, propylene oxide, 1,2-butylene oxide/2,3-butylene oxide and styrene oxide. It is preferable for propylene oxide and ethylene oxide to be introduced into the reaction mixture singly, in admixture or in succession. When the alkylene oxides are added in succession, the products obtained contain polyether chains having block structures. Products having ethylene oxide end-blocks are for example characterized by enhanced concentrations of primary end groups, which endow the systems with an advantageous isocyanate reactivity.

In a further embodiment, component A1 may also comprise polyether carbonate polyols as obtainable for example by catalytic reaction of alkylene oxides (epoxides) and carbon dioxide in the presence of H-functional starter substances (see, for example, EP-A 2046861). These polyether carbonate polyols generally have a hydroxyl functionality of 2 to 8, preferably of 2 to 6 and more preferably of 2 to 4. The OH number is preferably from ≧9 mg KOH/g to ≦112 mg KOH/g, more preferably from ≧10 mg KOH/g to ≦112 mg KOH/g.

Component A1 may also contain polymer polyols, a PUD polyol or a PIPA polyol. Polymer polyols are polyols that contain fractions of solid polymers created in a base polyol by free-radical polymerization of suitable monomers such as styrene or acrylonitrile. PUD (polyurea dispersion) polyols are formed for example by in situ polymerization of an isocyanate or of an isocyanate mixture with a diamine and/or hydrazine in a polyol, preferably a polyether polyol. The PUD dispersion is preferably obtained by reacting an isocyanate mixture used of a mixture of 75 to 85 wt % of 2,4-tolylene diisocyanate (2,4-TDI) and 15 to 25 wt % of 2,6-tolylene diisocyanate (2,6-TDI) with a diamine and/or hydrazine in a polyether polyol, preferably a polyether polyol prepared by alkoxylating a trifunctional starter (such as, for example, glycerol and/or trimethylolpropane). Processes for producing PUD dispersions are described for example in U.S. Pat. No. 4,089,835 and U.S. Pat. No. 4,260,530. PIM polyols are polyether polyols modified with alkanolamines by polyisocyanate polyaddition. PIPA polyols are more particularly described in GB 2 072 204 A, DE 31 03 757 A1 and U.S. Pat. No. 4,374,209 A.

Mixtures of component A 1 may also be present.

In one embodiment of the process according to the invention, component A1 contains
A1.1 at least one polyether polyol having a functionality of 2 to 6, preferably of 3 to 4, an EO content of 5 to 40 wt %, preferably of 5 to 30 wt %, more preferably 10 to 20 wt %, a DEN 53240 OH number of ≧9 mg KOH/g ≦112 mg KOH/g, preferably of ≧20 mg KOH/g to ≦40 mg KOH/g,
A1.2 optionally at least one polyether polyol having a functionality of 2 to 6, preferably of 3, an EO content of >60 wt %, preferably >70 wt %, a DIN 53240 OH number of ≦9 mg KOH/g to ≦112 mg KOH/g, preferably of ≧20 mg KOH/g to ≦50 mg KOH/g,
A1.3 optionally at least one dispersion of a polymer in a polyether polyol, wherein the DIN 53240 OH number of the dispersion is in the range from 9 to 60 mg KOH/g and wherein the polyether polyol has a hydroxyl functionality of 2 to 6, preferably of 2 to 4, more preferably of 3, a PO content in an amount of 70 to 90 wt % and an EO content in an amount of 10 to 30 wt %.

In this embodiment, the mass fractions of components A1.1 to A1.3 (independently of each other, where applicable) can be in the following ranges: A1.1 from 10 to 100 parts by weight, A1.2 from 0 to 10 parts by weight, A1.3 from 0 to 90 parts by weight, subject to the proviso that the parts by weight of A 1.1 to A 1.3 sum to 100.

In a further embodiment, the mass fractions of components A1.1 to A1.3 (independently of each other, where applicable) can be in the following ranges: A1.1 from 10 to 100 parts by weight, A1.2 from 1 to 9 parts by weight, A1.3 from 0 to 89 parts by weight, subject to the proviso that the parts by weight of A 1.1 to A 1.3 sum to 100.

Component A2

Component A2 comprises water and/or physical blowing agents. Useful physical blowing agents include, for example, carbon dioxide and/or volatile organics such as, for example, dichloromethane being used as blowing agents. Water is preferably used as blowing agent in an amount of 0.5 to 5.0 parts by weight, preferably of 1.0 to 4.0 parts by weight and more preferably of 2.0 to 3.2 parts by weight (based on 100 parts by weight of A1).

Component A3

Component A3, the use of which is optional, comprises compounds having at least two isocyanate-reactive hydrogen atoms and an OH number of 140 mg KOH/g to 1800 mg KOH/g. This is to be understood as meaning compounds having hydroxyl groups and/or amino groups and/or thiol groups and/or carboxyl groups, preferably hydroxyl- and/or amino-containing compounds used as extenders or crosslinkers. The number of isocyanate-reactive hydrogen atoms in these compounds is generally in the range from 2 to 8, preferably in the range from 2 to 4. Ethanolamine, diethanolamine, triethanolamine, sorbitol and/or glycerol, for example, are useful as component A3. Further examples of compounds useful as component A3 are described in EP-A 0 007 502, pages 16-17.

Component A4

Component A4 comprises auxiliary and added-substance materials such as
a) catalysts (activators),
b) surface-active added-substance materials (surfactants), such as emulsifiers and foam stabilizers especially those of low emission such as, for example, products of the Tegostab® LF series,
c) additives such as reaction retarders (e.g., acidic materials such as hydrochloric acid or organic acyl halides), cell regulators (such as, for example, paraffins or fatty alcohols or dimethylpolysiloxanes), pigments, dyes, flame retardants (such as, for example, tricresyl phosphate or ammonium polyphosphate), stabilizers against aging and weathering effects, plasticizers, fungistats, bacteriostats, fillers (such as, for example, barium sulfate, kieselguhr, carbon black chalk or precipitated chalk) and release agents.

These auxiliary and added-substance materials, the use of which is optional, are described for example in EP-A 0 000 389, pages 18-21. Further examples of auxiliary and added-substance materials for optional use in the present invention and also details as to ways these auxiliary and added-substance materials are used and function are described in Kunststoff-Handbuch, volume VII, edited by G. Oertel, Carl-Hanser-Verlag, Munich, 3^{rd} edition, 1993, for example on pages 104-127.

Preferred catalysts are aliphatic tertiary amines (for example trimethylamine, tetramethylbutanediamine), cycloaliphatic tertiary amities (for example 1,4-diaza(2,2,2)bicyclooctane), aliphatic aminoethers (for example dimethylaminoethyl ether and N,N,N-trimethyl-N-hydroxyethylbisaminoethyl ether), cycloaliphatic aminoethers (for example N-ethylmorpholine), aliphatic amidines, cycloaliphatic amidines, urea, derivatives of urea (such as, for example, aminoalkylureas, see for instance EP-A 0 176 013, in particular (3-dimethylaminopropylamine)urea) and tin catalysts (such as, for example, dibutyltin oxide, dibutyltin dilaurate, tin octoate).

Particularly preferred catalysts are:
α) urea, derivatives of urea, and/or
β) amities and aminoethers each containing a functional group which forms a chemical reaction with the isocyanate. The functional group is preferably a hydroxyl group or a primary or secondary amino group. These particularly preferred catalysts have the advantage of a much reduced tendency to migrate and emit.

Examples of particularly preferred catalysts are (3-dimethylaminopropylamine)urea, 2-(2-dimethylaminoethoxy)ethanol, N,N-bis(3-dimethylaminopropyl)-N-isopropanolamine, N,N,N-trimethyl-N-hydroxyethylbisaminoethyl ether and 3-dimethylaminopropylamine.

Component B

Polyisocyanates containing a mixture of di- and polyisocyanates of the diphenylmethane (MDI) series (B1) and optionally one or more polyether polyols (B2) having a functionality of 2 to 8, preferably of 2 to 6, a DIN 53240 OH number of ≧9 mg KOH/g to ≦56 mg KOH/g, preferably of ≧25 mg KOH/g to ≦45 mg KOH/g, wherein the ratio of 4,4′-MDI to 2,4′-MDI is between 1.6 and 2.7 and total monomer content is 75 to 85 wt %, based on the sum total of isocyanates used.

Component B can be used either in the form of a so-called isocyanate blend or in the form of an isocyanate-terminated urethane prepolymer.

When component B is in the form of an isocyanate blend, a mixture containing di- and polyisocyanates of the diphenylmethane (MDI) series (B1) is used, wherein this mixture has an 4,4′-MDI to 2,4MDI isomer ratio between 1.6 and 2.7, and total monomer content is in the range from 75 to 85 wt %, based on the sum total of isocyanates used.

When component B is used in the form of an isocyanate-terminated urethane prepolymer, the isocyanate-terminated urethane prepolymer is obtainable by reacting a mixture containing di- and polyisocyanates of the diphenylmethane (MDI) series (B1), wherein this mixture has a 4,4-MDI to 2,4′-MDI isomer ratio between 1.6 and 2.7 and total monomer content is in the range from 75 to 85 wt %, based on the sum total of isocyanates used, with one or more polyether polyols (B2) having a functionality of 2 to 8, preferably of 2 to 6, a DIN 53240 OH number of ≧9 mg KOH/g to ≦56 mg KOH/g, preferably of ≧25 mg KOH/g to ≦45 mg KOH/g, The NCO content of the urethane prepolymer is preferably in the range from 15 to 35 wt % and more preferably in the range from 22 to 32.5 wt %.

Components B1 and B2 are preferably reacted therein according to the methods known per se to a person skilled in the art. For example, components B1 and B2 can be mixed at a temperature of 20 to 80° C. to form the urethane prepolymer. In general, the reaction of components B1 and B2 will be complete after 30 min to 24 h with the formation of the NCO-terminated urethane prepolymer. Optionally, activators known to a person skilled in the art can be used for producing the NCO-terminated urethane prepolymer.

The urethane prepolymer of component B is also obtainable by first reacting a first portion of a mixture containing di- and polyisocyanates of the diphenylmethane (MDI) series (B1) with one or more polyether polyols (B2) having. a functionality of 2 to 8, preferably of 2 to 6, a DIN 53240 OH number of ≧9 mg KOH/g to ≦56 mg KOH/g, preferably of ≧25 mg KOH/g to ≦45 mg KOH/g to obtain a urethane prepolymer which in a further step is then mixed with a second portion of a mixture containing di- and polyisocyanates of the diphenylmethane (MDI) series (B1) to obtain the urethane prepolymer of component B with an NCO content of 15 to 35 wt %, preferably of 22 to 32.5 wt %,

In addition to the di- and polyisocyanates of the diphenylmethane (MDI) series (B1), further polyisocyanates may also be present in component B, in which case the total monomer content of the isocyanates used is in the range from 75 to 85 wt %.

Suitable polyisocyanates are aliphatic, cycloaliphatic, araliphatic, aromatic and heterocyclic polyisocyanates as described for example by W. Siefken in Justus Liebigs Annalen der Chemie, 562, pages 75 to 136, for example those of formula (1)

Q(NCO)ₙ, (1)

where
n=2-4, preferably 2-3,
and
Q is an aliphatic hydrocarbyl radical of 2-18, preferably 6-10 carbon atoms, a cycloaliphatic hydrocarbyl radical of 4-15, preferably 6-13 carbon atoms or an araliphatic hydrocarbyl radical of 8-15, preferably 8-13 carbon atoms.

Polyisocyanates as described in EP-A 0 007 502, pages 7-8, are concerned, for example. Preference is generally given to polyisocyanates that are readily available industrially, for example 2,4- and 2,6-tolylene diisocyanates, and also any desired mixtures of these isomers (“TDI”); to polyphenylpolymethylene polyisocyanates as obtained by aniline-formaldehyde condensation and subsequent phosgenation (“crude MDI”) and to polyisocyanates containing carbodiimide groups, urethane groups, allophanate groups, isocyanurate groups, urea groups or biuret groups (“modified polyisocyanates”), in particular to such modified polyisocyanates as derive from 2,4- and/or 2,6-tolylene diisocyanate and/or from 4,4′- and/or 2,4′-diphenylmethane diisocyanate. The polyisocyanate used is preferably at least one compound selected from the group consisting of 2,4- and 2,6-tolylene diisocyanates, 4,4′- and 2,4′- and 2,2′-diphenylmethane diisocyanates and polyphenylpolymethylene polyisocyanate (“polynuclear MDI”), while it is particularly preferable for the polyisocyanate used to be a mixture containing 4,4′-diphenylmethane diisocyanate, 2,4′-diphenylmethane diisocyanate, 2,2′-diphenylmethane diisocyanate and polyphenylpolymethylene polyisocyanate.

In one preferred embodiment of the process according to the invention, component B is selected from the group consisting of di- and polyisocyanates from the MDI series (B1) and optionally one or more polyether polyols (B2).

The components for producing the flexible PUR foam of the process according to the present invention are made to react by the conventional single-stage process, the prepolymer process or the semi-prepolymer process, often by using mechanical means, for example those described in EP-A 355 000. Details about processing means which are useful for the purposes of the invention as well are described in Kunststoff-Handbuch, volume VII, edited by Vieweg and Höchtlen, Carl-Hanser-Verlag, Munich 1993, for example on pages 139 to 265. The mixture of components initiates the polymerization and the foaming up of the polymerizing material. Particularly in the production of molded flexible PUR foams it is often the case that polymerization and shaping take place in one step, typically by shaping or spraying the reaction mixture while it is still in the liquid state. Molded foams are also obtainable by hot curing or else cold curing.

If, then, a molded flexible PUR foam of defined composition is to be obtained, the components described above are appropriately dosed before they are mixed. Foaming up is normally achieved in the process by admixing component A with water which reacts with the polyisocyanate component B to form an amine and release CO₂ which in turn functions as blowing gas. Alternatively or additionally to the use of water, volatile inert organic compounds or inert gases are often also used.

The flexible PUR foams obtained by the process according to the invention have a DIN EN ISO 3386-1-98 apparent density in the range from ≧63 kg/m³ to ≦83 kg/m³ and a DIN EN ISO 3386-1-98 compression load deflection (in the 4^{th} cycle at 40% compression) in the range from ≧5.0 kPa to ≦9.0 kPa and also a DIN EN ISO 2439-1-2009 hysteresis loss of ≦16.

The flexible PUR foams obtained by the process according to the invention have an ethylene oxide (EC)) fraction of ≦30 wt %, preferably ≦20 wt %, based on the sum total of all alkylene oxide fractions in the polyether polyols used for producing the flexible PUR foam.

The process of the present invention is preferably used for producing molded flexible PUR foams and the mold cavities used reflect the structure of the desired foamed molding. The PUR foams obtainable by the process according to the invention are used, for example, for furniture cushioning, textile inserts, mattresses, automotive seats, headrests, arm rests, sponges and component elements, and also seat and dashboard trim, preferably for furniture cushioning, textile inserts, mattresses, automotive seats and headrests.

### EXAMPLES

The isocyanate index indicates the ratio of the actually used isocyanate quantity to the stoichiometric, i.e., computed, isocyanate (NCO) quantity:

isocyanate index=[(isocyanate quantity used):(isocyanate quantity computed)]·100 (11)

Apparent density was determined in accordance with DIN EN ISO 845:

OH number was determined in accordance with DIN 53240.

Compression load deflection (CLD 4/40) was determined in accordance with DIN EN ISO 3386-1-98 in the 4th cycle at 40% compression.

Hysteresis loss (CLD) was determined in accordance with DIN EN ISO 2439-1-2009.

Raw materials used:
polyol A1.1: glycerol-started EO-terminated ethylene oxide-propylene oxide polyether polyol having an OH number of 27 and an ethylene oxide content of about 16 wt % based on the sum total of ethylene oxide and propylene oxide, obtained via KOH-catalyzed addition reaction.
polyol A1.2: glycerol-started EO-terminated ethylene oxide-propylene oxide polyether polyol having an 011 number of 37 and an ethylene oxide content of about 72 wt % based on the sum total of ethylene oxide and propylene oxide, obtained via KOH-catalyzed addition reaction.

Tegostab® B8734LF2 foam stabilizer from Evonik Industries AG, DE

Jeffcat® ZR50 additive from Huntsman

DABCO NE300 additive from Air Products

To investigate the influence of isocyanate component B on the quality of PUR foam, Examples B-1 and B-2 use the same polyol formulation in polyol A (Table 1). A further Inventive Example B-III comprises reacting polyol B (Table 1), which incorporates polyol 132 from prepolymer B-II, with isocyanate blend B-III.

TABLE 1
Polyol formulations for producing the PUR foams

| | | Polyol A | Polyol B |
|---|---|---|---|
| | OH | parts by | parts by |
| | number | weight | weight |
| polyol A1.1 | 27 | 96.000 | 83.180 |
| polyol A1.2 | 37 | 4.000 | 3.470 |
| polyol B2 | 27 | | 13.350 |
| water (A2) | 6228 | 2.900 | 2.510 |
| diethanolamine (A3) | 1601 | 0.400 | 0.350 |
| Tegostab ® B8734LF2 (A4) | 83 | 0.300 | 0.260 |
| Jeffcat ® ZR50 (A4) | 221 | 0.600 | 0.520 |
| DABCO NE300 (A4) | 276 | 0.150 | 0.130 |

Isocyanate Component:
polyol 132: sorbitol-started EO-terminated ethylene oxide-propylene oxide polyether polyol having an OH number of 28 mg KOH/g and an ethylene oxide content of 17 wt % based on the sum total of ethylene oxide and propylene oxide
B1.1 diphenylmethane diisocyanate (MDI) having an NCO content of 33.6%
B1.2 monomeric diphenylmethane diisocyanate (mMDI) with <1 wt % of 2,2′-MDI, 50±5 wt % of 2,4′-MDI and 50±5 wt % of 4,4′-MDI and also an NCO content of 33.6%
B1.3 high-monomer polymeric MDI having an NCO content of 32.5 and <3.5 wt % of 2,2′-MDI, about 25 wt % of 2,4′-MDI, about 60 wt % of 4,4′-MDI and about 15 wt % of polyphenyl polyisocyanate
B1.4 polymeric MDI having an NCO content of 31.5 and <1 wt % of 2,2′-MDI, about 5 wt % of 2,4′-MDI, about 35 wt % of 4,4′-MDI and about 60 wt % of higher homologs

The prepolymers were produced in line with the formulation indicated in Table 2 by initially charging the isocyanate mixture at 40° C. to a 10 l glass flask and admixing the stated amount of polyol 132 under agitation without the temperature of 80° C. being exceeded. Prepolymer fabrication was completed by cooling down to room temperature following a stirring time of three hours.

TABLE 2
Formulation for producing component B (prepolymers
B-I and B-II and also isocyanate blend B-III)

| Isocyanate | | B-I | | |
|---|---|---|---|---|
| component | | (comparator) | B-II | B-III |
| polyol B2 | [wt %] | 23.39 | 23.34 | — |
| B1.1 | [wt %] | 18.4 | 5.68 | 7.41 |
| B1.2 | [wt %] | 17.27 | 29.46 | 38.43 |
| B1.4 | [wt %] | 23.06 | 23.66 | 30.86 |
| B1.3 | [wt %] | 17.88 | 17.86 | 23.3 |
| Sum total | | 100 | 100 | 100 |
| NCO content | [wt %] | 24.5 | 24.5 | 32.5 |
| Total mMDI fraction¹ | [wt %] | 83.06 | 82.75 | 82.75 |
| 2,2′-MDI fraction | [wt %] | 0.95 | 1.02 | 1.02 |
| 2,4′-MDI fraction | [wt %] | 20.29 | 29.29 | 29.29 |
| 4,4′-MDI fraction | [wt %] | 61.82 | 52.45 | 52.45 |
| Ratio of 4,4′:2,4′-MDI | | 3 | 1.8 | 1.8 |

¹mMDI: monomeric MDI

The starting components of Tables 1 and 2 were imported into a heated aluminum mold at 60° C. via a two-component high-pressure metering and mixing machine under customary processing conditions for the production of molded flexible polyurethane foams. Following a reaction time of 4 min, the fully reacted foams were demolded.

TABLE 3
Properties of high-resilience flexible
foams obtained with B-I (comparator).
Isocyanate component B-I (comparator)

| Example | 1 (c) | 2 (c) | 3 (c) | 4 (c) | 5 (c) |
|---|---|---|---|---|---|
| isocyanate index | 105 | 100 | 100 | 100 | 90 |
| part density [kg/m³] | 75.3 | 80.1 | 75.1 | 65.2 | 75.1 |
| apparent density [kg/m³] | 77.9 | 82.6 | 77.6 | 67.3 | 76.8 |
| CLD 4/40 [kPa] | 10.9 | 9.5 | 9.1 | 7.1 | 6.8 |
| CLD hysteresis loss [%] | 20 | 18 | 19 | 19 | 19 |

TABLE 4
Properties of high-resilience flexible foams obtained with B-II
Isocyanate component B-II

| Example | 6 | 7 | 8 | 9 | 10 |
|---|---|---|---|---|---|
| isocyanate index | 105 | 100 | 100 | 100 | 90 |
| part density [kg/m³] | 75 | 80 | 75 | 65.3 | 75.8 |
| apparent density [kg/m³] | 74.9 | 79.9 | 74.6 | 66.1 | 76.6 |
| CLD 4/40 [kPa] | 8.7 | 8.1 | 7.2 | 6.1 | 6.0 |
| CLD hysteresis loss [%] | 16 | 14 | 14 | 13 | 15 |

TABLE 5
Properties of high-resilience flexible foams obtained with B-III
Isocyanate component B-III (blend)

| Example | 11 | 12 | 13 |
|---|---|---|---|
| isocyanate index | 105 | 100 | 90 |
| part density [kg/m³] | 75 | 75 | 75 |
| apparent density [kg/m³] | 74.9 | 75.3 | 76.4 |
| CLD 4/40 [kPa] | 8.9 | 7.5 | 6.2 |
| CLD hysteresis loss [%] | 16 | 15 | 14 |

The attempt to convert a prepolymer having a <1.4 ratio of 4,4′-MDI to 2,4′-MDI isomers into a molded foam led to a very soft, difficult-to-demold foam unsuitable for use in the manufacture of seating foams.

Examples 2 (c) to 4 (c) of Table 3 and Examples 7 to 9 of Table 4 show that changing the part density for a given formulation has minimal effect on the hysteresis.

Similarly, the hardness decrease due to index reduction only has a minimal effect on hysteresis (Examples 1(c), 3(c), 5(c) and 6, 8, 10).

The examples of Table 3 do not meet current requirements for the production of flexible PUR. foams having a hysteresis of ≦16.

By contrast, the low hysteresis desired is consistently achievable on using the inventive prepolymers (Table 4) or isocyanate blends (Table 5).

1-13. (canceled)

14. A process for producing flexible PUR foams having a DIN EN ISO 3386-1-98 apparent density in the range of ≧63 kg/m³ to <83 kg/m³ and a DIN EN ISO 2439-1-2009 hysteresis of ≦16 comprising reacting component A comprising
A1 at least one polyether polyol having a functionality of 2 to 6, a DIN 53240 hydroxyl number (OH number) of 9 to 112 mg KOH/g, an ethylene oxide fraction of 5 to 40 wt %, based on the sum total of alkylene oxides used,
A2 water and/or physical blowing agents,
A3 optionally isocyanate-reactive hydrogen compounds having an OH number of 140 mg KOH/g to 1800 mg KOH/g,
A4 auxiliary and added-substance materials such as
a) catalysts,
b) surface-active added-substance materials, and
c) pigments or flame retardants,
wherein component A is free of polyricinoleic esters,
with
component B comprising
a mixture of di- and polyisocyanates of the diphenylmethane (MDI) series (B1), optionally one or more polyether polyols (B2) having a functionality of 2 to 8, preferably of 2 to 6, a DIN 53240 OH number of ≧9 mg KOH/g to ≦56 mg KOH/g, wherein the ratio of 4,4′-MDI to 2,4′-MDI is between 1.6 and 2.7 and total monomer content is 75 to 85 wt %, based on the sum total of isocyanates used,
wherein the flexible PUR foam is produced at an isocyanate index of 75 to 110.

15. The process as claimed in claim 14 wherein component Al contains at least one polyether polyol having a functionality of 2 to 6, a DIN 53240 hydroxyl number (OH number) of 9 to 112 mg KOH/g, an ethylene oxide fraction of 10 to 20 wt %, based on the sum total of alkylene oxides used.

16. The process as claimed in claim 14 comprising component A1 at 100 parts by weight;
component A2 at 0.5 to 5 parts by weight, based on 100 parts by weight of component A1;
component A3 at 0 to 10 parts by weight, based on 100 parts by weight of component A1, and
component A4 at 0.05 to 10 parts by weight, based on 100 parts by weight of component A1.

17. The process as claimed in claim 14 wherein component A2 is water.

18. The process as claimed in claim 14 wherein the amount of component A2 is from 2.0 to 3.2 parts by weight, based on 100 parts by weight of A1.

19. The process as claimed in claim 14 wherein component A1 comprises
A1.1 at least one polyether polyol having a functionality of 2 to 6, an EO content of 5 to 40 wt %, a DIN 53240 OH number of ≧9 mg KOH/g to ≦112 mg KOH/g,
A1.2 optionally at least one polyether polyol having a functionality of 2 to 6, an EO content of >60 wt %, a DIN 53240 OH number of ≧9 mg KOH/g to ≦112 mg KOH/g,
A1.3 optionally at least one dispersion of a polymer in a polyether polyol, wherein the DIN 53240 OH number of the dispersion is in the range from 9 to 60 mg KOH/g and wherein the polyether polyol has a hydroxyl functionality of 2 to 6, a PO content in an amount of 70 to 90 wt % and an EO content in an amount of 10 to 30 wt %.

20. The process as claimed in claim 14 wherein component B is an isocyanate-terminated urethane prepolymer obtained by reacting a mixture containing di- and polyisocyanates of the diphenylmethane (MDI) series (B1), wherein this mixture has a 4,4′-MDI to 2,4′-MDI isomer ratio between 1.6 and 2.7 and total monomer content is in the range from 75 to 85 wt %, based on the sum total of isocyanates used, with one or more polyether polyols (B2) having a functionality of 2 to 8, a DIN 53240 OH number of ≧9 mg KOH/g to ≦56 mg KOH/g.

21. The process as claimed in claim 20 wherein the urethane prepolymer has an NCO content of 22 to 32.5 wt %.

22. The process as claimed in claim 14 wherein component B is selected from the group consisting of di- and polyisocyanates from the MDI series (B1) and optionally one or more polyether polyols (B2).

23. The process as claimed in claim 14 wherein the flexible PUR foams are produced as molded foams in a cold-cure process.

24. A flexible polyurethane foam obtained by the process as claimed in claim 14.

25. The flexible polyurethane foam as claimed in claim 24 wherein the flexible PUR foam has an ethylene oxide (EO) fraction of ≦30 wt %, based on the sum total of all alkylene oxide fractions in the polyether polyols used for producing the flexible PUR foam.

26. A method comprising utilizing the flexible polyurethane foam as claimed in claim 24 in the manufacture of furniture cushioning, textile inserts, mattresses, automotive seats, headrests, arm rests, sponges, component elements, and dashboard trim.
